(19) United States
(12) Patent Application Publication
(10) Pub. No.: US 2010/0172121 A1
(43) Pub. Date: Jul. 8, 2010

(54) SELF-SUPPORTING LUMINESCENT FILM AND PHOSPHOR-ENHANCED ILLUMINATION SYSTEM

(75) Inventors: Rifat Ata Mustafa Hikmet, Eindhoven (NL); Henricus Albertus Maria Van Hal, Vessem (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/602,202

(22) PCT Filed: May 27, 2008
(86) PCT No.: PCT/IB08/52077

§ 371 Date: Nov. 30, 2009

(30) Foreign Application Priority Data
Jun. 5, 2007 (EP) 07109584.8

(51) Int. Cl. F21V 9/16; B29C 59/04; C09K 11/02

(52) U.S. Cl. 362/84; 264/175; 252/301.36

(57) ABSTRACT

The invention relates to a self-supporting luminescent film (10), a phosphor-enhanced illumination system and to a method of manufacturing the self-supporting luminescent film. The self-supporting luminescent film comprises luminescent particles (20) and an organic polymer (30). The luminescent particles comprise luminescent material which is arranged for absorbing at least part of the impinging light impinging on the luminescent particles and for converting the absorbed light into converted light. The converted light has a predefined spectrum different from the impinging light. The organic polymer interconnects the luminescent particles to form the self-supporting luminescent film, wherein the self-supporting luminescent film comprises less than 10 weight percentage of organic polymer. The effect of the measures according to the invention is that the close packing of the luminescent particles generates a substantially uniform self-supporting luminescent film.

### FIELD OF THE INVENTION

The invention relates to a self-supporting luminescent film.

The invention also relates to a phosphor-enhanced illumination system comprising the self-supporting luminescent film and a method of producing the self-supporting luminescent film.

### BACKGROUND OF THE INVENTION

Self-supporting fluorescent cover having a phosphor dispersed in the self-supporting material are known per se. They are used, inter alia, in phosphor-enhanced light emitting diodes for shifting, changing and/or enhancing the spectral output of light emitting diodes. The known self-supporting fluorescent covers are arranged to cover a light-emitting die of a light emitting diode. The fluorescent material dispersed in the self-supporting material absorbs at least part of the light emitted by the light-emitting die and converts the absorbed light into light having a predefined spectrum. The light converted by the fluorescent material is subsequently emitted by the phosphor-enhanced light emitting diode, possibly together with the part of the light emitted by the light-emitting die which is not absorbed by the fluorescent material.

Generally, the self-supporting fluorescent cover results in a remote arrangement of the fluorescent material. This remote arrangement is also referred to as a remote-phosphor configuration. A benefit when using the remote-phosphor configuration is that the conversion efficiency and the life-time of the fluorescent material are improved and that the range of luminescent materials to choose from is improved.

Such self-supporting fluorescent cover is known from WO 2005/025831 in which a transmissive optical element is disclosed fabricated by filling a mold with molten liquid that includes a transparent plastic and a phosphor additive. Allowing the molten liquid to solidify produces a transmissive optical element having phosphor dispersed therein.

A drawback when using the self-supporting fluorescent cover is that the uniformity of the light emitted from the fluorescent cover is not optimal.

### SUMMARY OF THE INVENTION

It is an object of the invention to improve a uniformity of the emitted light from a self-supporting cover.

According to a first aspect of the invention the object is achieved with a self-supporting luminescent film according claim 1. According to a second aspect of the invention, the object is achieved with a phosphor-enhanced illumination system as claimed in claim 6. The self-supporting luminescent film according to the invention comprises luminescent particles and an organic polymer, the luminescent particles comprising luminescent material being arranged for absorbing at least part of the impinging light impinging on the luminescent particles and for converting the absorbed light into converted light having a predefined spectrum different from the impinging light, the organic polymer interconnecting the luminescent particles to form the self-supporting luminescent film, the self-supporting luminescent film comprising less than 10 weight percentage of organic polymer.

The effect of the self-supporting luminescent film according to the invention is that the luminescent particles are arranged in a close packing which generates a substantially uniform self-supporting luminescent film. Only a very small amount of organic polymer material is required for holding the luminescent particles fixed in the self-supporting luminescent film. Due to the uniform distribution of the luminescent particles in the self-supporting luminescent film, the converted light emitted by the self-supporting luminescent film will also be substantially uniform. In the known transmissive optical element the transparent plastic forms a significant part of the transmissive optical element which influences the optical characteristics of the light emitted by the transmissive optical element and which typically reduce the uniformity of the emitted light. Furthermore, the phosphor additive is distributed in the transparent plastic. It is relatively difficult to maintain a good distribution of the phosphor additive during the curing of the transparent plastic, which may result in a non-uniform distribution of the phosphor additive in the transparent plastic, which causes the uniformity of the emitted light not to be optimal. In the self-supporting luminescent film according to the invention, the close packing of the luminescent particles ensure that the distribution of the luminescent particles in the self-supporting luminescent film are substantially uniform, resulting in an improved uniformity of the emitted light from the self-supporting luminescent film.

A further benefit of the self-supporting luminescent film according to the invention is that the concentration of the luminescent particles in the self-supporting luminescent film is very high. As a result, the self-supporting luminescent film may be relatively thin to convert a predetermined part of the impinging light into converted light. For example, when the impinging light is ultraviolet light, preferably all impinging light is converted by the self-supporting luminescent film into converted light which is visible light. In such an embodiment a self-supporting luminescent film having a thickness of less than 100 micrometer is required to convert substantially all impinging light into converted light.

An even further benefit of the self-supporting luminescent film according to the invention is that the optical characteristics of the self-supporting luminescent film can be determined before applying the self-supporting luminescent film to a light source to generate a phosphor enhanced light source. Generally, the luminescent material is applied in a droplet covering the die of the light emitting diode. Such a droplet generally does not comprise a homogeneous distribution of the luminescent material. Furthermore, the exact optical characteristics, for example, resulting from a thickness of the droplet of luminescent material is difficult to control and cannot be determined upfront. When using the self-supporting luminescent film according to the invention, the optical properties such as absorbance and emission characteristics can be determined upfront due to the fact that the self-supporting luminescent film is self-supporting. The optical properties of the self-supporting luminescent film may, for example, be matched with the optical characteristics such as emission spectrum of the light emitting diodes. Often the optical characteristics of light emitting diodes differ slightly and therefore, the light emitting diodes are often binned to collect the light emitting diodes having substantially the same optical characteristics. This same principle of binning may be applied to the self-supporting luminescent film after which the light emitting diodes of a certain optical characteristic may be combined with the self-supporting luminescent film having a predefined optical property to generate a phosphor enhanced illumination system having the required emission characteristics. Due to the fact that the self-supporting luminescent film is self-supporting, it can be handled and characterized substantially in the same manner as any optical element before being combined with a matching light source, for example, a matching light emitting diode to obtain desired properties such a certain color temperature.

In this context, light of a predefined spectrum includes, for example, light having a specific bandwidth around a predefined wavelength, or, for example, includes a primary color or a plurality of primary colors. The predefined wavelength, for example, is a mean wavelength of a radiant power spectral distribution. The light of a primary color, for example, includes the most common primary colors such as red, green, blue light. By choosing, for example, a specific combination of the red, green and blue light, substantially every color can be generated by the self-supporting luminescent film, including white. If the light source is an ultraviolet light emitting light emitting diode, the luminescent material converts the ultraviolet light into converted light, for example, white. If the light source is a blue-emitting light emitting diode, the luminescent material converts part of the blue light into, for example, yellow light to obtain white light. In such a system blue light is not totally absorbed and partially leaks through and gets mixed with yellow light and the total spectrum looks white.

In an embodiment of the self-supporting luminescent film, the organic polymer comprises an ultra-high-molecular-weight polymer and/or a ductile polymer. An ultra-high-molecular-weight polymer has a molecular weight above 1 million. These ultra-high-molecular weight polymers may be ductile. A benefit when using ultra-high-molecular-weight polymers is that the ultra-high-molecular-weight polymers interconnect the luminescent particles in such a way that the self-supporting luminescent film, in spite of a high content of luminescent particles, is relatively strong and less susceptible to crack formation and disintegration. A ductile polymer generally forms a neck when under strain and can be stretched a certain length. Using a ductile polymer results in a deformable and flexible self-supporting luminescent film. The processing of the ultra-high-molecular-weight polymer may involve solvents. The ultra-high-molecular-weight polymer, for example, is first dissolved in a solvent followed by the addition of the luminescent particles. The solvent may, for example, be removed by drying or extraction. Alternatively, the ultra-high-molecular-weight polymer may be mixed with the luminescent particles as a powder and milled to produce the film.

In an embodiment of the self-supporting luminescent film, a size of the luminescent particles generates a porous self-supporting luminescent film for being impregnated by a resin. A benefit of this embodiment is that the porous self-supporting luminescent film may, for example, be fixed by impregnating it with the resin. The self-supporting luminescent film may, for example, be flexible and shaped according to a predefined form which is fixed via impregnation with the resin. In an embodiment of the phosphor-enhanced illumination system, the light source is enclosed in the resin, and the self-supporting luminescent film is impregnated with the resin. For example, a die of a light emitting diode is generally embedded in a resin to protect the die from environmental influences and to facilitate light emission from the die by reduce a change in refractive index between the die and its surroundings. When the self-supporting luminescent material is applied to the die, the impregnation of the self-supporting luminescent film with the same resin as the resin with which the die is surrounded further improves the optical characteristics of the phosphor-enhanced illumination system because the index of refraction of the self-supporting luminescent film is substantially equal to the index of refraction of the enclosure of the die. Generally, an interface separating two materials having different index of refraction causes part of the light to reflect from the interface. When the self-supporting luminescent film would not be embedded with the same resin as used to encapsulate the die, part of the light emitted by the die of the light emitting diode will be reflected back to the die and may be partially absorbed, reducing an efficiency of the light emitting diode. Impregnating the self-supporting luminescent film with the same resin as used to encapsulate the die, the index of refraction of the self-supporting luminescent film is substantially equal to the index of refraction of the resin surrounding the die. Substantially no interface occurs between the encapsulating resin and the self-supporting luminescent film which avoids reflection of the light emitted from the die and thus improves the efficiency. For example, a silicon rubber may be used as the resin. Silicon rubber is especially used as encapsulation material of light emitting diodes emitting ultraviolet light because silicon rubber is substantially transparent to ultraviolet light.

In an embodiment of the self-supporting luminescent film, the luminescent particles comprise a mixture of different luminescent materials. A benefit of this embodiment is that the use of a mixture of different luminescent materials typically improves a color rendering index of the converted light emitted by the self-supporting luminescent film. A color rendering index (also indicated as CRI) is a measure of the ability of a light source to reproduce the spectrum of a black body at a certain temperature. Especially in a general lighting application a relatively high color rendering index is required to ensure that the perceived color when illuminating the object is substantially equal to when illuminated with a black body source such as incandescent lamp of the corresponding color temperature. Using a mixture of different luminescent materials enable a designer to tune the spectrum of the converted light or to tune the spectrum of the mixed impinging light and converted light to closely resemble the spectrum of a black-body radiator which closely resembles the light emitted by the sun.

In an embodiment of the self-supporting luminescent film, the self-supporting luminescent film comprises first luminescent particles and comprises second luminescent particles, the first luminescent particles comprising luminescent material or comprising a mixture of luminescent materials different from the second luminescent particles. A benefit of this embodiment is that it enables a relatively simple altering of the spectrum of the light emitted by the self-supporting luminescent film. Mixing different luminescent particles in, for example, a predefined ratio, a specific spectrum of the converted light can be generated. Altering the ratio or, for example, exchanging the luminescent material in the first luminescent particles and/or the second luminescent particles alters the specific spectrum.

In an embodiment of the phosphor-enhanced illumination system, a spectrum of the light emitted by the light source comprises ultraviolet light and/or blue light.

In an embodiment of the phosphor-enhanced illumination system, the self-supporting luminescent film is arranged between the light source and a reflective layer reflecting light back towards the light source. Between the self-supporting film and the light source, and between the self-supporting film and the reflective layer some additional layer or layers of different substantially translucent materials may be present. Such a phosphor-enhanced illumination system emits light in a direction substantially parallel to the self-supporting luminescent film, resulting in a phosphor-enhanced side-emitting illumination system.

According to a third aspect of the invention, the object is achieved with a method of manufacturing the self-supporting luminescent film as claimed in claim 8.

In an embodiment of the manufacturing method for manufacturing the self-supporting luminescent film, the method comprises the steps of:

mixing the luminescent particles in a solution comprising an ultra-high-molecular-weight polymer for generating a solution, the solution comprising less than 10 weight percentage of ultra-high-molecular-weight polymer, and

curing the ultra-high-molecular-weight polymer to generate the self-supporting luminescent film.

The manufacturing method further comprising the casting the solution which comprises the ultra-high-molecular-weight polymer and the luminescent particles, and the removing the solvent. This manufacturing method enables the processing of ultra-high-molecular-weight polymer to form a self-supporting film.

In an embodiment of the manufacturing method for manufacturing the self-supporting luminescent film, the method comprises the steps of:

mixing the luminescent particles with particles of a ductile polymer for generating a mixture, the mixture comprising less than 10 weight percentage of ductile polymer, and

applying pressure to the mixture for interconnecting the luminescent particles via the ductile polymer to generate the self-supporting luminescent film.

A benefit of this manufacturing method is that it generates the self-supporting luminescent film using a relatively simple manufacturing method. Only the uniform mixing of the luminescent particles and the ductile polymer is required. When applying pressure to the mixture, the particles of ductile polymer bond the luminescent particles together to form the self-supporting luminescent film.

In an embodiment of the manufacturing method, the step of applying pressure to the mixture comprises using a roller, i.e. a relatively heavy drum, for rolling over the mixture. A benefit of this embodiment is that the roller may be used to control a thickness of the self-supporting luminescent film. As indicated before, the close packing of the particles cause a very efficient light conversion layer for converting the impinging light into converted light. Therefore, only a relatively thin self-supporting luminescent film is required. Using a roller may, next to applying the pressure, reduce and control the thickness of the self-supporting luminescent film to control the conversion of the predetermined part of the impinging light into converted light.

In an embodiment of the manufacturing method for manufacturing the self-supporting luminescent film, the method comprises the steps of:

mixing the luminescent particles with a monomer,

applying a layer of the solution to a surface, and

curing the monomer to form a polymer generating the self-supporting luminescent film.

The monomer forms a coating around the luminescent particles. A benefit of this manufacturing method is that it does not involve additional solvent and milling steps.

### BRIEF DESCRIPTION OF THE DRAWINGS

These and other aspects of the invention are apparent from and will be elucidated with reference to the embodiments described hereinafter.

In the drawings:

FIGS. 1A and 1B show schematic cross-sectional views of a self-supporting luminescent film according to the invention,

FIGS. 2A and 2B show a schematic cross-sectional views of a phosphor-enhanced illumination system comprising the self-supporting luminescent film applied to a die,

FIG. 3 shows a cross-sectional view of a further embodiment of the phosphor-enhanced illumination system comprising the self-supporting luminescent film applied remote from the die,

FIG. 4 shows a cross-sectional view of a further embodiment of the phosphor enhanced illumination system comprising the self-supporting luminescent film in which the die is embedded in a resin,

FIG. 5 shows a cross-sectional view of a further embodiment of the phosphor-enhanced illumination system according to the invention,

FIG. 6 shows a cross-sectional view of a further embodiment of the phosphor-enhanced illumination system according to the invention, and

FIG. 7 shows some processing steps for shaping the self-supporting luminescent film according to the invention.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF EMBODIMENTS

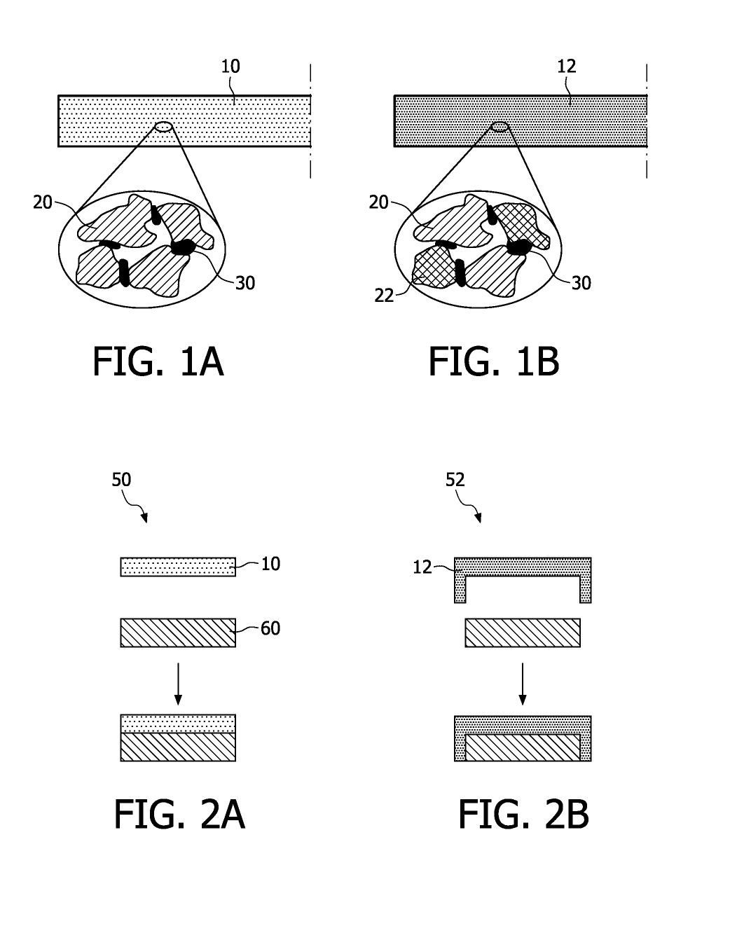

FIGS. 1A and 1B show schematic cross-sectional views of a self-supporting luminescent film 10, 12 according to the invention. The self-supporting luminescent film 10, 12 comprises luminescent particles 20, 22 which comprise luminescent material. Luminescent material typically absorbs at least part of the impinging light being light emitted by a light source 60 (see FIGS. 2, 3, 4 and 5) and converts the absorbed light into converted light having a predefined spectrum different from the impinging light. The self-supporting luminescent film further comprises an organic polymer 30 for interconnecting the luminescent particles 20, 22 to form the self-supporting luminescent film 10, 12. Using less than 10 weight percent and preferably less than 5 weight percent of organic polymer 30 particles, the luminescent particles 20, 22 in the self-supporting luminescent film 10, 12 are arranged in a close packing of particles leading to a substantially uniform self-supporting luminescent film 10, 12.

The organic polymer 30 may, for example be an ultra-high-molecular-weight polymer 30 having a molecular weight above 1 million. These ultra-high-molecular-weight polymers 30 interconnect the luminescent particles 20, 22 in such a way that the self-supporting luminescent film 10, 12, in spite of a high content of luminescent particles 20, 22, is relatively strong and less susceptible to crack formation and disintegration. The organic polymer 30 may alternatively be a ductile polymer 30 which forms a neck when under strain and can be stretched a certain length. Some of the ultra-high-molecular-weight polymers 30 are ductile. Using the ductile polymer 30 in the self-supporting luminescent film 10, 12 results in the self-supporting luminescent film 10, 12 to be deformable and/or flexible which enables the self-supporting luminescent film 10, 12 to be shaped in substantially any shape. Furthermore, the used of the ductile polymer 30 enables, for example, a control a thickness of the self-supporting luminescent film 10, 12 by stretching of the self-supporting luminescent film 10, 12.

The impinging light generally is light having a relatively short wavelength such as ultraviolet light or blue light. The luminescent material converts at least a part of the impinging light into converted light which is generally visible light. However, also other conversions of the impinging light to converted light may be chosen without departing from the scope of the claims.

FIG. 1A shows part of a self-supporting luminescent film 10 according to the invention in which the self-supporting luminescent film comprises luminescent particles 20 bonded via the organic polymer 30. FIG. 1B shows part of a self-supporting luminescent film 12 according to the invention in which the self-supporting luminescent film comprise first luminescent particles 20 and second luminescent particles 22 bonded via the organic polymer 30. The first luminescent particles 20 comprise luminescent material or comprise a mixture of luminescent materials different from the second luminescent particles 22.

Due to the close packing of the luminescent particles 20, 22 the conversion efficiency of the self-supporting luminescent film 10, 12 is relatively high which result in the use of only relatively thin self-supporting luminescent film 10, 12 to convert substantially all impinging light into converted light. This is especially beneficial when the self-supporting luminescent film 10, 12 is used in a phosphor-enhanced illumination system 50, 52, 54, 56, 58 (see FIGS. 2, 3, 4 and 5) in which the light source 60 emits ultraviolet light which must be converted by the self-supporting luminescent film 10, 12 into visible light. Only a relatively thin self-supporting luminescent film 10, 12 may be used to ensure that substantially no ultraviolet light is emitted from the phosphor-enhanced illumination system 50, 52, 54, 56, 58. Especially when the phosphor-enhanced illumination system 50, 52, 54, 56, 58 is used in a general lighting application, the emission of ultraviolet light preferably is avoided because ultraviolet light is harmful for the human eye.

Furthermore, due to the self-supporting characteristics of the self-supporting luminescent film 10, 12, the optical characteristics of the self-supporting luminescent film 10, 12 may be determined before combining the self-supporting luminescent film 10, 12 with the light source 60 to form the phosphor-enhanced illumination system 50, 52, 54, 56, 58. This is especially beneficial for generating a phosphor-enhanced illumination system 50, 52, 54, 56, 58 of which the spectrum of the light emitted by the illumination system should be well defined. Typically binning is used to select light sources 60 such as light emitting diodes 60 of which the emission characteristics are within a predefined range. By determine the optical characteristics of the self-supporting luminescent film 10, 12 before applying the self-supporting luminescent film 10, 12 to a light source 60, the self-supporting luminescent film 10, 12 may be binned in the same manner as is done with the light sources 60. The relevant optical characteristics of the self-supporting luminescent film 10, 12, for example, are a level of transmission of the impinging light through the self-supporting luminescent film 10, 12, or, for example, a spectrum of the converted light emitted by the self-supporting luminescent film 10, 12. As a result, a specific bin comprising the self-supporting luminescent film 10, 12 may be chosen to match a matching bin of light sources 60. When combining the self-supporting luminescent film 10, 12 from the specific bin with a light source 60 from the matching bin, a phosphor-enhanced illumination system is generated having a well defined emission spectrum.

In the known self-supporting fluorescent covers the self-supporting fluorescent cover may comprise a luminescent material embedded in a polymer. Typically, the cover is constituted of a polymer forming a continuous polymer matrix. Such a continuous polymer matrix typically is not porous but forms a substantially closed structure which may comprise encapsulated holes. This closed structure is generally chosen to avoid contamination to enter the covers thus altering the optical characteristics of the cover. However, due to the closed structure, the encapsulated holes cannot be filled with resin 40 (see FIG. 4). The resin 40 may be used to match the index of refraction of the fluorescent cover to the index of refraction of the resin 40 encapsulating the light source 60 which reduces reflection of light emitted by the light source 60 back to the light source 60 and also reduce excess multiple scattering which can lead to losses. Typically, part of the light reflecting back to the light source 60 is absorbed by the light source 60 and lost, resulting in a reduced efficiency of the light source 60. The self-supporting luminescent film 10, 12 according to the invention comprises relatively large luminescent particles 20, 22 which are interconnected by organic polymer 30 to form a porous self-supporting luminescent film 10, 12. The porosity of the self-supporting luminescent film 10, 12 is such that the self-supporting luminescent film 10, 12 may be impregnated by resin 40 (see FIG. 4). Due to the impregnation of the self-supporting luminescent film 10, 12 the index of refraction of the self-supporting luminescent film 10, 12 substantially matches the index of refraction of the resin 40 encapsulating the light source 60 which reduces reflection of light emitted from the light source 60 back to the light source 60, increasing an efficiency of the light source 60.

Luminescent material to be used in the self-supporting luminescent film 10, 12 according to the invention in combination with a light source 60 emitting light of the primary color blue, for example, comprises Y₃Al₅O₁₂:Ce³⁺ (further also referred to as YAG:Ce). YAG:Ce absorbs impinging light of the primary color blue and subsequently emits converted light of the primary color yellow. Choosing a specific thickness of the self-supporting luminescent film 10, a specific part of the impinging light of the primary color blue is converted to the converted light of the primary color yellow. The remaining impinging light is transmitted by the self-supporting luminescent film 10 and mixes with the converted light. The mixed light is emitted by the phosphor-enhanced illumination system 50, 52, 54, 56, 58 to form, for example, white light to be emitted. Alternatively, the luminescent particles 20 of the self-supporting luminescent film 10 comprise a mixture of Y₃Al₅O₁₂:Ce³⁺ and CaS:Eu²⁺ (further also referred to as CaS:Eu). The adding to CaS:Eu shifts the converted light from yellow to amber and shifts a color-temperature of the white light emitted by the phosphor-enhanced illumination system 50, 52, 54, 56, 58 to a warm-white color-point. Alternatively, the self-supporting luminescent film 12 comprises first luminescent particles 20 and second luminescent particles 22 in which the first luminescent particles 20 comprising different luminescent material compared to the second luminescent particles 22. For example, the first luminescent particles 20 comprise YAG:Ce and the second luminescent particles 22 comprises CaS:Eu. When changing a mixture of the first luminescent particles 20 and the second luminescent particles, the color temperature of the phosphor-enhanced illumination system 50, 52, 54, 56, 58 is changed. Alternatively, the luminescent material may, for example, comprise (Ba,Sr)₂Si₅N₈:Eu²⁺ (converting impinging light of the primary color blue into converted light of the primary color amber), or, for example, a mixture of Lu₃Al₅O₁₂:Ce³⁺ (converting impinging light of the primary color blue into converted light of the primary color green) and CaS:Eu. Other luminescent materials that convert impinging light of the primary color blue into converted light of the primary color red, such as (Ba,Sr,Ca)₂Si₅N₈:Eu²⁺, (Sr,Ca)S: Eu²⁺, and (Ca,Sr)AlSiN₃:Eu²⁺, can be used instead of CaS:Eu, reaching substantially the same effect. Other luminescent materials that convert impinging light of the primary color blue into converted light of the primary color green, such as Sr₂Si₂N₂O₂:Eu²⁺, and SrGa₂S₄:Eu²⁺, can be used instead of LuAG:Ce, reaching substantially the same effect. The garnet luminescent materials YAG:Ce and LuAG:Ce can be replaced by (Y_{3-x-y}LuₓGd_{y})(Al_{5-z}Si_{z})(O_{12-z}N_{z}):Ce having 0<x≦3, 0≦y≦2.7, 0<x+y≦3 and 0<z≦2.

Luminescent material to be used in the self-supporting luminescent film 10, 12 according to the invention in combination with a light source 60 emitting ultraviolet light, for example, comprises a mixture of BaMgAl₁₀O₁₇:Eu²⁺ (converting impinging ultraviolet light into converted light of the primary color blue), Ca₈Mg(SiO₄)₄Cl₂: Eu²⁺,Mn²⁺ (converting impinging ultraviolet light into converted light of the primary color green), and Y₂O₃:Eu³⁺,Bi³⁺ (converting impinging ultraviolet light into converted light of the primary color red). Choosing different ratio of the luminescent materials in the self-supporting luminescent film 10, 12 enable a shift of the color temperature of the converted light from relatively cold white to warm white, for example between 6500K and 2700K. Any other color change is possible as well, determined by the phosphor ratio. Any other luminescent material converting ultraviolet light into blue, green or red light or any other primary color can be used instead of the luminescent materials mentioned above.

The self-supporting luminescent film 10, 12 according to the invention may be produced using different production methods. The organic polymer 30 may, for example, be an ultra-high-molecular-weight polymer. The ultra-high-molecular-weight polymer may, for example, be mixed in a solution with the luminescent particles 20, 22 after which the solution is cured to generate the self-supporting luminescent film 10, 12. Alternatively, the organic polymer 30 may be constituted of particles of a ductile polymer 30 which may, for example, be mixed with the luminescent particles 20, 22. When applying pressure to the mixture of ductile polymer particles 30 and luminescent particles 20, 22, the ductile polymer 30 bonds the luminescent particles 20, 22 together to form the self-supporting luminescent film 10, 12. Changing the pressure applied to the mixture of ductile polymer particles 30 and luminescent particles 20, 22 changes a thickness of the self-supporting luminescent film 10, 12 which influences, for example, the transmission characteristics of the self-supporting luminescent film 10, 12 for the impinging light. The luminescent particles 20, 22 may also be mixed with a monomer. Applying the monomer together with the luminescent particles 20, 22 on to a surface (not shown) and curing the monomer to form a polymer 30 generates the self-supporting luminescent film 10, 12. Preferably the surface is a non-sticking surface.

FIGS. 2A and 2B show a schematic cross-sectional views of a phosphor-enhanced illumination system 50, 52 comprising the self-supporting luminescent film 10, 12 applied to a die 60. The upper part of the FIGS. 2A and 2B show the self-supporting luminescent film 10, 12 and the die 60 separately, for example, before assembly. The lower part of the FIGS. 2A and 2B show the self-supporting luminescent film 10, 12 applied directly to the die 60. The optical characteristics of the self-supporting luminescent film 10, 12 may be determined before the self-supporting luminescent film 10, 12 is applied onto the die 60. The optical characteristics of the self-supporting luminescent film 10, 12, for example, may include the transmission characteristics of the self-supporting luminescent film 10, 12 for the impinging light, or may, for example, include a characterization of the spectrum of the converted light emitted by the self-supporting luminescent film 10, 12. By characterizing the self-supporting luminescent film 10, 12 before applying the self-supporting luminescent film 10, 12 to the die 60, the self-supporting luminescent film 10, 12 may be binned and matched with correspondingly binned dies 60 to generate a predetermined color of the light emitted by the phosphor-enhanced illumination system 50, 52 according to the invention.

Alternatively, the phosphor-enhanced illumination system may comprise a plurality of self-supporting luminescent films (not shown). In an embodiment in which the self-supporting luminescent films in the plurality of self-supporting luminescent films are substantially identical, the number of films determines a conversion efficiency of the luminescent material and as such a color of the light emitted by the phosphor-enhanced illumination system. In an embodiment in which the self-supporting luminescent films in the plurality of self-supporting luminescent films are different, each film typically emits converted light having a different spectrum which, when mixed, results in a specific color emitted by the phosphor-enhanced illumination system.

In a preferred embodiment of the phosphor-enhanced illumination system 50, 52, 54, 56, 58 according to the invention, the light source 60 is a light emitting diode 60 (further also referred to as LED). However, the light source 60 may be any suitable light source 60, such as a low-pressure discharge lamp, a high-pressure discharge lamp, an incandescent lamp or a laser light source.

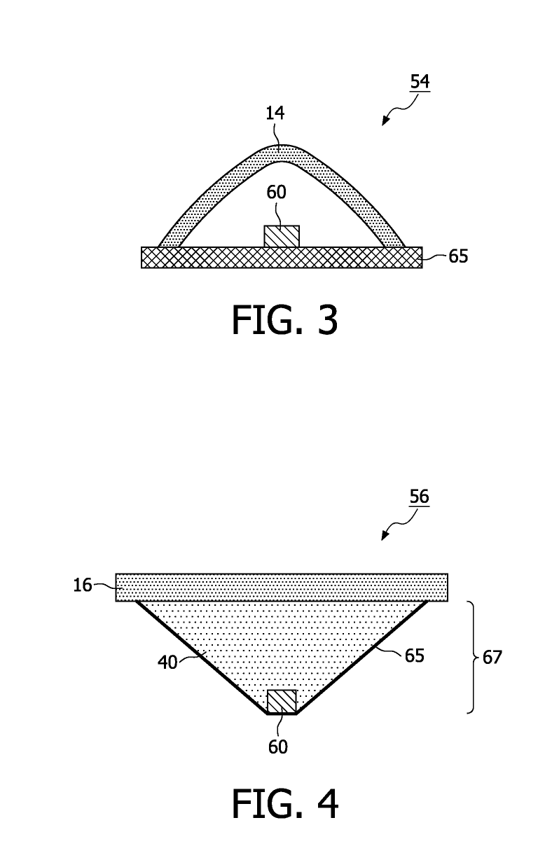

FIG. 3 shows a cross-sectional view of a further embodiment of the phosphor-enhanced illumination system 54 comprising the self-supporting luminescent film 14 applied remote from the die 60. The die 60 is preferably arranged on a diffuse reflector 65. The arrangement of the self-supporting luminescent film 14 as shown in FIG. 3 is also referred to as a remote-phosphor configuration. In the remote-phosphor configuration the luminescent material is located at a distance from the die 60 which results in a lower temperature of the luminescent material and a reduced light-flux per surface area of luminescent material compared to a configuration in which the luminescent material is directly applied to the die 60. A benefit when using the remote-phosphor configuration is that the conversion efficiency and the life-time of the luminescent material are improved and that the range of luminescent materials to choose from to be applied in the self-supporting luminescent film 14 is improved.

FIG. 4 shows a cross-sectional view of a further embodiment of the phosphor-enhanced illumination system 56 comprising the self-supporting luminescent film 16 in which the die 60 is embedded in a resin 40. The die 60 is generally embedded in a resin 40 to protect the die 60 from environmental influences and to facilitate light emission from the die 60 by reduce the change in refractive index between the die 60 and its surroundings. Impregnating the self-supporting luminescent film 16 with the same resin as used to embed the die 60 further enhances the optical characteristics of the phosphor-enhanced illumination system 56 because the index of refraction of the self-supporting luminescent film 16 is substantially equal to the index of refraction of the resin 40 enclosing the die 60. The self-supporting luminescent film 16 is porous to enable the resin 40 to impregnate the self-supporting luminescent film 16. Preferably the porosity may be controlled by a size or a size distribution of the luminescent particles 20, 22. Alternatively the porosity may be controlled by stretching the composite film to reduce the packing density of the particles. In the embodiment shown in FIG. 4, the die 60 is arranged in a reflector cup 67 constituted, for example, of a diffuse reflector 65.

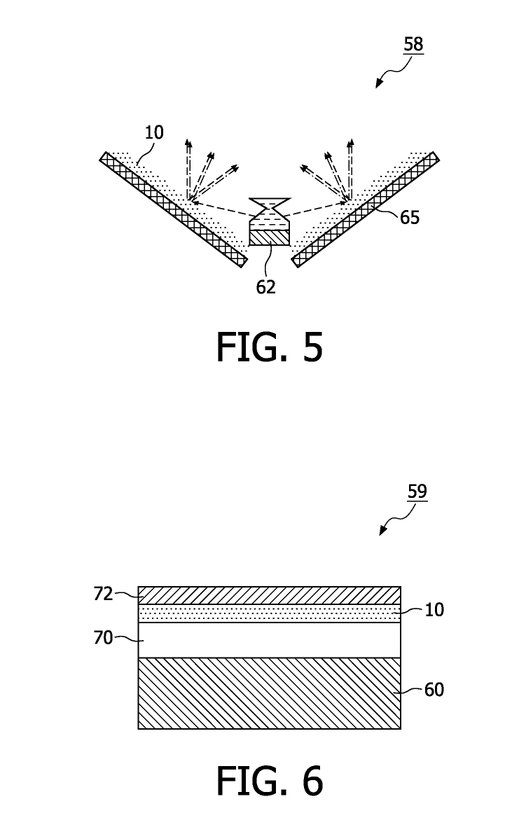

FIG. 5 shows a cross-sectional view of a further embodiment of the phosphor-enhanced illumination system 58 according to the invention. The phosphor-enhanced illumination system 58 shown in FIG. 5 comprises a side-emitting light emitting diode 62 which is surrounded by a diffuse reflector 65 comprising the self-supporting luminescent film 10 according to the invention. The side-emitting LED 62 emits, for example, light of the primary color blue (indicated in FIG. 5 with a dashed arrow) towards the diffuse reflector 65. Before the light from the side-emitting LED 62 is reflected by the diffuse reflector 65 the light of the primary color blue impinges on the self-supporting luminescent film 10. A part of the light of the primary color blue is converted by the luminescent material in the self-supporting luminescent film 10 to converted light, for example, light of the primary color yellow (indicated in FIG. 5 with the dash-dotted arrows). The part of the impinging light which is not converted by the luminescent material mixes with the converted light and determines the color of the light emitted by the phosphor-enhanced illumination system 58. Generally the impinging light which transmits through the self-supporting luminescent film 10 is scattered by the self-supporting luminescent film 10 to enhance the mixing of the impinging light with the converted light. In the arrangement of the phosphor-enhanced illumination system 58 as shown in FIG. 5, the light emitted by the side-emitter LED 62 travels through the self-supporting luminescent film 10 twice. As a result, the thickness of the self-supporting luminescent film 10 may be further reduced.

FIG. 6 shows a cross-sectional view of a further embodiment of the phosphor-enhanced illumination system 59 according to the invention. The phosphor-enhanced illumination system 59 comprises a light emitting diode 60 having a substantially transparent layer 70 or having a scattering layer 70 directly applied to the light emitting diode 60. Next, the self-supporting luminescent film 10 and a reflective layer 72 are applied respectively on top of the transparent layer 70 or scattering layer 70. The reflective layer 72 may, for example, be a reflecting metal layer 72, a dielectric coating 72 or a diffuse scattering layer 72 of particles. It may also, for example, be a diffuse reflecting layer 72. In the configuration shown in FIG. 6, light emitted by the light emitting diode 60 is at least partially converted by the self-supporting luminescent film 10. Because the self-supporting luminescent film 10 is covered by a reflective layer 72 light is emitted in a direction substantially parallel to the self-supporting luminescent film 10.

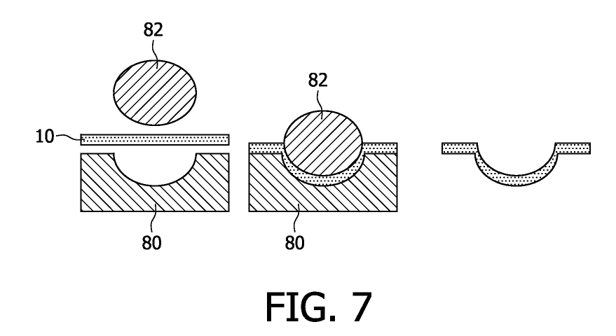

FIG. 7 shows some processing steps for shaping the self-supporting luminescent film 10 according to the invention. The self-supporting luminescent film 10, for example, comprises a ductile polymer 30 (see FIG. 1A) and may be shaped using a mould 80 and a press 82. Applying the press 82 to the self-supporting luminescent film 10 forces the self-supporting luminescent film 10 to take the shape of the mould 80. Subsequently the shape of the self-supporting luminescent film 10 is fixed, for example, by impregnating the self-supporting luminescent film 10 with a resin. Alternatively, the self-supporting luminescent film 10 is heated to enable the self-supporting luminescent film 10 to be shaped using the mould 80 and the press 82. Subsequently, the self-supporting luminescent film 10 is cooled to such that the shape if fixed. The self-supporting luminescent film 10 may be produced having a well defined thickness and thus having a well defined optical characteristic, after which it is deformed and subsequently fixed. This results in a fixed shape of the self-supporting luminescent film having a well defined optical characteristic. The known method the shape the transmissive self-supporting fluorescent covers uses injection molded to generate a shape of the cover. Using injection molding limits the possibility to predetermine the optical characteristic of the self-supporting luminescent film 10 prior to shaping the self-supporting luminescent film 10 and thus limits the possibility to predetermine the optical characteristic of the cover before it is produced. Furthermore, using injection molding to produce the cover typically produces a relatively thick cover. Such a relatively thick cover requires a relatively low concentration of the luminescent material distributed in the transparent plastic which may cause non-uniformities in the light emitted by the cover. The self-supporting luminescent film 10 according to the invention is self-supporting and thus can be produced and characterized before being shaped and applied to the light source 60, 62 to generate a phosphor-enhanced illumination system 50, 52, 54, 56, 58 having a well defined emission spectrum.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. A self-supporting luminescent film comprising luminescent particles and an organic polymer comprising an ultra-high-molecular-weight polymer and/or a ductile polymer, the luminescent particles comprising luminescent material being arranged for absorbing at least part of the impinging light impinging on the luminescent particles and for converting the absorbed light into converted light having a predefined spectrum different from the impinging light, the organic polymer interconnecting the luminescent particles to form the self-supporting luminescent film, the self-supporting luminescent film comprising less than 10 weight percentage of organic polymer.

2. (canceled)

3. Self-supporting luminescent film as claimed in claim 1, wherein a size of the luminescent particles generates a porous self-supporting luminescent film for being impregnated by a resin.

4. Self-supporting luminescent film as claimed in claim 1, wherein the luminescent particles comprise a mixture of different luminescent materials.

5. Self-supporting luminescent film as claimed in claim 1, wherein the self-supporting luminescent film comprises first luminescent particles and comprises second luminescent particles, the first luminescent particles comprising luminescent material or comprising a mixture of luminescent materials different from the second luminescent particles.

6. A phosphor-enhanced illumination system comprising a light source and the self-supporting luminescent film as claimed in claim 1.

7. Phosphor-enhanced illumination system as claimed in claim 6, wherein the light source is enclosed in a resin, and wherein the self-supporting luminescent film is impregnated with the resin.

8. Phosphor-enhanced illumination system as claimed in claim 6, wherein a spectrum of the light emitted by the light source comprises ultraviolet light and/or blue light.

9. Phosphor-enhanced illumination system as claimed in claim 6, wherein the self-supporting luminescent film is arranged between the light source and a reflective layer reflecting light back towards the light source.

10. Method of manufacturing a self-supporting luminescent film as claimed in claim 1, the method comprising the steps of:
mixing the luminescent particles in a solution comprising an ultra high molecular weight polymer for generating a solution, the solution comprising less than 10 weight percentage of ultra-high-molecular-weight polymer, and
curing the ultra-high-molecular-weight polymer to generate the self-supporting luminescent film.

11. Method of manufacturing a self-supporting luminescent film as claimed in claim 1, the method comprising the steps of:
mixing the luminescent particles with particles of a ductile polymer for generating a mixture, the mixture comprising less than 10 weight percentage of ductile polymer, and
applying pressure to the mixture for interconnecting the luminescent particles via the ductile polymer to generate the self-supporting luminescent film.

12. Method of manufacturing the self-supporting luminescent film as claimed in claim 11, wherein the step of applying pressure to the mixture comprises using a roller for rolling over the mixture.

13. Method of manufacturing the self-supporting luminescent film as claimed in claim 1, the method comprising the steps of:
mixing the luminescent particles with a monomer
curing the monomer to form a polymer generating the self-supporting luminescent film.
